(19) United States
(12) Patent Application Publication
(10) Pub. No.: US 2025/0192628 A1
(43) Pub. Date: Jun. 12, 2025

(54) ROTOR LAMINATED CORE FOR A ROTOR OF AN ELECTRIC MACHINE, HAVING A TERMINAL LAMINATION

(71) Applicant: Valeo eAutomotive Germany GmbH, Erlangen (DE)

(72) Inventors: Alexander SCHLERETH, Bad Neustadt a. d. Saale (DE); Bernhard KESSLER, Bad Neustadt a. d. Saale (DE); Guillaume TOURAIN, Erlangen (DE); Andre SAUVIGNET, Erlangen (DE)

(73) Assignee: Valeo eAutomotive Germany GmbH, Erlangen (DE)

(21) Appl. No.: 18/977,009

(22) Filed: Dec. 11, 2024

(30) Foreign Application Priority Data
Dec. 12, 2023 (DE) 102023134858.2

(51) Int. Cl. H02K 1/276; H02K 15/03

(52) U.S. Cl. CPC H02K 1/276; H02K 15/03

(57) ABSTRACT

A rotor laminated core for a rotor of an electric machine has a plurality of rotor laminations which are stacked axially one on the other and each have a recess. The recesses form a magnet pocket for receiving a rotor magnet. The rotor laminated core has a terminal lamination which is arranged on the axial side of the rotor laminated core and has a further recess which is axially aligned with the recess in the adjacent rotor lamination and is narrowed with respect to the recess in the adjacent rotor lamination.

The invention relates to a rotor laminated core for a rotor of an electric machine, which rotor laminated core has a plurality of rotor laminations which are stacked axially one on the other and each have a recess (or a hole), wherein the recesses form a magnet pocket for receiving a rotor magnet. The invention also relates to a rotor for an electric machine, to an electric machine having a rotor, to a vehicle having an electric machine, and to a production method for a rotor of an electric machine.

A permanently excited rotor according to the prior art has a rotor laminated core having a plurality of rotor laminations stacked axially one on the other, wherein the axial direction runs parallel to the rotation axis of the rotor.

A plurality of permanent magnets, referred to as “rotor magnets”, which serve to generate a rotor magnetic field are arranged in the rotor laminated core. The rotor laminated core has magnet pockets for receiving the rotor magnets, the magnet pockets each extending from one axial side of the rotor laminated core to its opposite axial side. Furthermore, the rotor has a rotor shaft which extends axially through a central passage opening in the rotor laminated core.

When producing the rotor, the rotor magnets can be arranged in the rotor laminated core, before the rotor laminated core is mounted on the rotor shaft. This procedure is followed, in particular, in the case of what is referred to as a “bevelled” rotor. A plurality of rotor laminated cores or rotor segments are mounted on the rotor shaft of such a rotor, wherein the magnetic poles of one rotor laminated core are rotated with respect to the magnetic poles of another rotor laminated core about the rotation axis of the rotor.

In order to arrange the rotor magnets in the rotor laminated core, the rotor laminated core is oriented in such a way that its rotation axis runs vertically. The rotor magnets are then inserted into the magnet pockets of the rotor laminated core from above. There is a risk here of the rotor magnets falling or slipping downwards out of the rotor laminated core due to gravity. This risk also exists in a further production step, in which the rotor laminated core is pushed onto the rotor shaft from above, and during transportation of the rotor laminated core for this production step.

After all of the rotor laminated cores have been secured on the rotor shaft, the rotor magnets can be potted using a potting compound in order to reliably secure the rotor magnets, so that the rotor magnets do not become loose or detached during operation of the electric machine.

The object of the invention is that of preventing the rotor magnets of a rotor from falling out of the rotor laminated core of the rotor during assembly the rotor.

The object is achieved by a rotor laminated core according to the invention which has a terminal lamination which is arranged on the axial side of the rotor laminated core and has a further recess which is axially aligned with the recess in the adjacent rotor lamination and is narrowed with respect to the recess in the adjacent rotor lamination.

During assembly of the rotor, when the rotor laminated core is oriented in such a way that its rotation axis runs vertically and the terminal lamination is located on the bottom side of the rotor laminated core, the narrowing blocks a rotor magnet inserted into the magnet pocket from slipping or falling out of the rotor laminated core. The recess in the terminal lamination also makes it possible for liquid potting compound to flow downwards out of the rotor laminated core during the subsequent potting of the rotor magnet, as a result of which the formation of undesired air pockets in the potting compound which remains in the magnet pocket is avoided.

In addition to the said recess, each rotor lamination can have further recesses which form further magnet pockets for receiving further rotor magnets. In this case, the terminal lamination can also have further recesses which are each axially aligned with a recess in the adjacent rotor lamination and narrowed with respect to this recess.

Furthermore, the rotor laminated core can have an axial passage opening through which a rotor shaft can be guided.

In one embodiment of the rotor laminated core, the recess in the terminal lamination is formed identically to the recess in the adjacent rotor lamination, apart from one or more projections which form the narrowing and project into the recess in the terminal lamination. As a result, the punching tool used for producing the terminal lamination hardly has to be modified with respect to the punching tool used for producing the adjacent rotor lamination. The identical design can be understood to mean that the two recesses have the same shape, arrangement and alignment on the rotor lamination.

The recess in the terminal lamination optionally has two mutually opposite edge sections, wherein the projections are arranged on both edge sections. In other words, the projections are distributed over both edge sections. Tilting of a rotor magnet bearing against the narrowing can be prevented in this way. By way of example, the two edge portions can be straight, wherein they can run parallel to each other or form an angle. As an alternative to this, it is also possible for all of the projections to be arranged on only one edge section.

In particular, a projection can be arranged on a first edge section, wherein a point which is situated opposite the projection on the second edge section is situated between two projections arranged on the second edge section, for example centrally between the two projections. In this way, tilting of the rotor magnet can be avoided using a minimal number of projections, specifically only three projections.

Furthermore, it is possible for one projection or each projection to have an end section in the form of a segment of a circle. The end section is therefore of particularly stable design, so that undesired bending of the end section is avoided.

The object is further achieved by a rotor according to the invention which has a rotor shaft with a rotor laminated core according to the invention arranged, in particular secured, on the rotor shaft. A rotor magnet, which bears axially against the narrowing, is received in the magnet pocket of the rotor laminated core. The narrowing prevents the rotor magnet from slipping or falling out of the magnet pocket during assembly of the rotor.

In addition to the rotor magnet, further rotor magnets can be received in the magnet pocket, wherein the rotor magnets can be, in particular, axially lined up. Furthermore, the rotor can have further magnet pockets, one magnet or a plurality of magnets being received in the further magnet pockets in this way.

In one embodiment of the rotor, a free space is formed between the rotor magnet and the plurality of rotor laminations stacked axially one on the other, the free space being provided for a potting compound with which the rotor magnet can be potted. The recess in the terminal lamination is then arranged such that it is axially aligned with the free space. As a result, potting compound which has flowed into the free space can particularly readily flow out of the free space, as a result of which the formation of undesired air pockets in the potting compound which remains in the free space is avoided.

In a further embodiment of the rotor, a further rotor laminated core, which corresponds to the abovementioned rotor laminated core, is arranged on the rotor shaft. Here, magnetic poles of the two rotor laminated cores are rotated with respect to each other about the rotor shaft or rotation axis of the rotor. In other words, magnetic poles of one of the rotor laminated cores are rotated with respect to magnetic poles of the other rotor laminated core. The rotational behaviour of the rotor can be improved in this way.

In a further embodiment of the rotor, each of the rotor magnets is potted using a potting compound. As a result, the rotor magnets are reliably fixed in the rotor laminated core, so that the rotor magnets do not become loose or detached during operation of the electric machine.

The object is further achieved by an electric machine according to the invention which has a rotor according to the invention and a stator, the rotor being rotatably mounted with respect to the stator.

Furthermore, the object is achieved by a vehicle which has an electric machine according to the invention which is designed for driving the vehicle.

Moreover, the object is achieved by a production method for a rotor according to the invention, in which production method the following method steps are carried out:
orienting a rotor laminated core, so that a rotation axis of the rotor laminated core runs vertically and the terminal lamination of the rotor laminated core is arranged on the bottom side of the rotor laminated core,
inserting the rotor magnet into the magnet pocket of the oriented rotor laminated core, so that the rotor magnet bears axially against the narrowing,
orienting the rotor shaft, so that the rotor shaft runs vertically, and
pushing the oriented rotor laminated core with the rotor magnet onto the rotor shaft.

In one embodiment of the production method, a further rotor laminated core corresponding to the rotor laminated core is pushed onto the rotor shaft or secured on the rotor shaft, so that magnetic poles of the two rotor laminated cores are rotated with respect to each other about the rotor shaft.

Embodiments of the invention are explained in more detail below on the basis of the following schematic figures, in which:

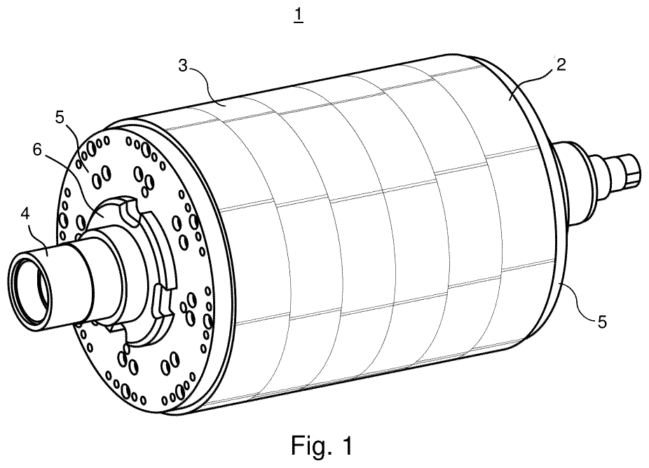

FIG. 1 is a perspective view of a bevelled rotor according to the invention,

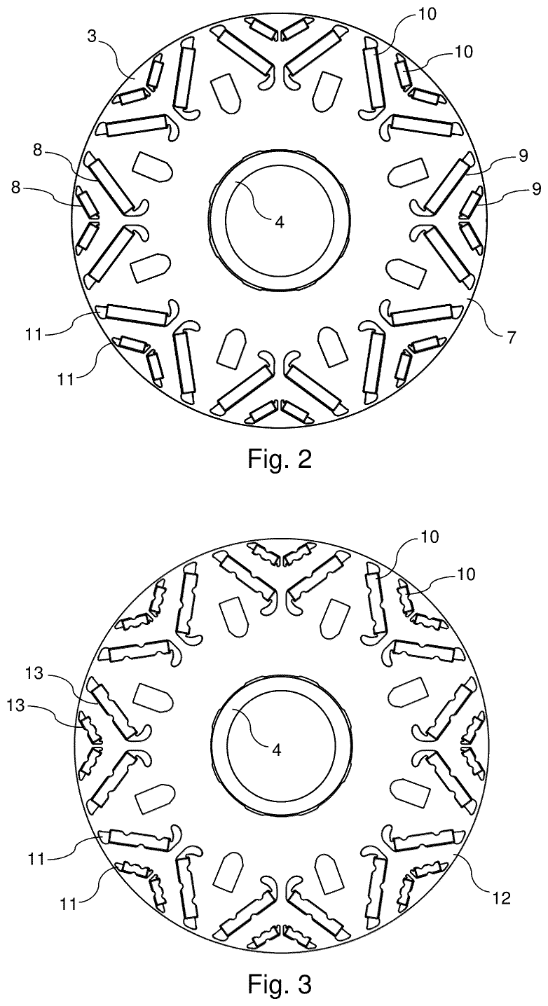

FIG. 2 shows an axial section through the rotor from FIG. 1,

FIG. 3 shows a further axial section through the rotor from FIG. 1,

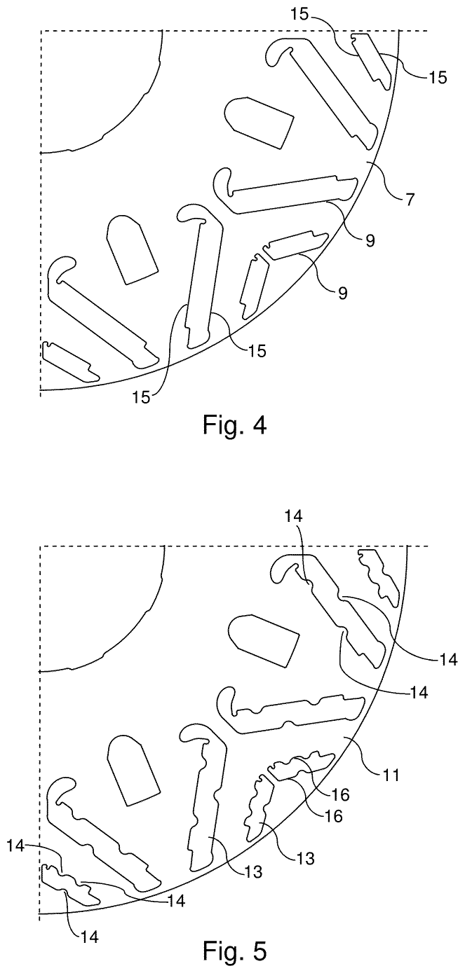

FIG. 4 shows a detail of a rotor lamination of the rotor from FIG. 1, and

FIG. 5 shows a detail of a terminal lamination of the rotor from FIG. 1.

FIG. 1 shows a schematic perspective illustration of a bevelled rotor 1 according to the invention. The rotor 1 forms part of an electric machine, which also has a stator, the rotor 1 being rotatably mounted with respect to the stator.

The rotor 1 has a cylindrical rotor body 2 with six rotor laminated cores 3 lined up axially next to each other. However, a rotor according to the invention may also have a different number of rotor laminated cores, for example one, two, three, four, five, seven, eight, nine or ten rotor laminated cores.

The rotor body 2 is mounted on a rotor shaft 4 which extends through an axial passage opening in the rotor body 2 along a (virtual) rotation axis of the rotor 1.

The rotor laminated cores 3 each have a plurality of magnetic poles formed by rotor magnets (not shown), wherein the magnetic poles are rotated with respect to each other about the rotor shaft 4. In particular, the magnetic poles of each rotor laminated core 3 are rotated with respect to the magnetic poles of at least one adjacent rotor laminated core 3. In the present case, the rotor laminated cores 3 are rotated in a V-shaped manner, which is symbolized by the thin lines. However, the rotor laminated cores of a rotor according to the invention can also be rotated differently, for example linearly.

Furthermore, two circular rotor end plates 5 are arranged on opposite axial sides of the rotor body 2. The rotor body 2 with the rotor end plates 5 is axially fixed between a shaft shoulder and a shaft nut 6. However, a rotor body according to the invention can also be axially fixed on a rotor shaft in another way, amongst others with a press fit and/or without rotor end plates.

FIG. 2 shows an axial section through the rotor 1 from FIG. 1, the axial section running through a rotor laminated core 3.

The rotor laminated core 3 has a plurality of rotor laminations 7 stacked axially one on the other, only one of which is shown in FIG. 2 and this one rotor lamination covering the rotor laminations 7 situated behind it. The rotor laminations 7 are specifically of identical design and are stacked congruently. Furthermore, the rotor laminated core 3 has a plurality of magnet pockets 8 which are each formed by recesses 9 in the rotor laminations 7.

One rotor magnet 10 is received in each magnet pocket 8. As an alternative to this, it is also possible for a plurality of rotor magnets to be received in one magnet pocket of a rotor laminated core according to the invention.

In the present case, the rotor magnets 10 are arranged in eight groups which each comprise four rotor magnets 10 arranged in a double V shape and form a magnetic pole. However, a different number and arrangement of rotor magnets is also possible in a rotor laminated core according to the invention. A rotor magnetic field is generated by the magnetic poles.

A respective free space 11 is formed at the radial ends of each rotor magnet 10, the free space being able to be filled with a potting compound, for example with a resin. The rotor magnets 10 are reliably fixed in the rotor laminated core 3 by the potting compound, so that the rotor magnets 10 do not become loose or detached during operation of the electric machine.

The rotor shaft 4 is also shown, for which hatching has been dispensed with for reasons of clarity. In addition to the plurality of rotor laminations 7, the rotor laminated core 3 also includes a terminal lamination which is arranged on an axial side of the rotor laminated core 3 and is not shown in FIG. 2.

FIG. 3 shows a further axial section through the rotor 1 from FIG. 1, the axial section running on the outside of the terminal lamination 12.

The terminal lamination 12 has a plurality of recesses 13, which are each axially aligned with a magnet pocket 8 of the rotor laminated core 3 or with a recess 9 in the adjacent rotor lamination 7 of the rotor laminated core 3. According to the invention, each recess 13 is narrowed with respect to the associated recess 9 in the adjacent rotor lamination 7 or magnet pocket 8.

In the present case, each recess 13 in the terminal lamination 12 is formed identically to the associated recess 9 in the adjacent rotor lamination 7, apart from three projections which form the narrowing and project into the recess 13 and are explained in more detail with reference to FIG. 5.

The rotor magnets 10 received in the magnet pockets 8 and the rotor shaft 4 are also shown. The rotor magnets 10 each bear axially against the narrowing or the three projections, which form the narrowing, of the associated recess 13.

FIG. 4 shows a detail of a rotor lamination 7 of a rotor laminated core 3 of the rotor 1 from FIG. 1.

The figure shows, in particular, the recesses 9 which, together with identical recesses 9 in the other rotor laminations 7 of the rotor laminated core 3, which includes the rotor lamination 7, form the magnet pockets 8 for receiving the rotor magnets 10.

Each recess 9 is of elongate design and has two mutually opposite straight edge sections 15. In the present case, there are two types of recesses 9—specifically relatively large recesses 9 and relatively small recesses 9. The relatively large recesses 9 are arranged in a V-shaped manner in pairs, and the relatively small recesses 9 are likewise arranged in a V-shaped manner in pairs, so that two relatively large recesses 9 and two relatively small recesses 9 form a double-V arrangement.

There are two free regions at the ends of each recess 9, these free regions, in the fully assembled rotor 1, forming the free spaces 11 together with the corresponding regions of the other rotor laminations 7 of the rotor laminated core 3. Each free space 11 is delimited by a rotor magnet 10 and the rotor laminated core 3.

FIG. 5 shows a detail of a terminal lamination 11 of a rotor laminated core 3 of the rotor 1 from FIG. 1.

The figure shows, in particular, the recesses 13 which are each aligned with a recess 9 in the adjacent rotor lamination 7 and are narrowed with respect to this recess 9.

In the present case, each recess 13 in the terminal lamination 12 is formed identically to the associated recess 9 in the adjacent rotor lamination 7, apart from three projections 14 which form the narrowing and project into the recess 9. Instead of three projections, it is also possible to provide a different number of projections, for example one, two, four, five or six projections.

The projections 14 of a recess 13 are arranged on two opposite edge sections 16 of the recess 13. As an alternative to this, the projections could also be arranged on only one of two opposite edge sections of the recess.

In particular, the projections 14 of the recess 13 are arranged in such a way that one projection 14 is arranged on a first edge section 16 and a point which is situated opposite the projection on the second edge section 16 is situated centrally between two projections 14 arranged on the second edge section 16. Furthermore, the projections 14 are configured such that each projection 14 has an end section in the form of a segment of a circle.

In the rotor laminated core 3, each recess 13 is axially aligned with the free spaces 11 of the associated magnet pocket 8. In particular, two free regions of the recess 13, which are formed at the ends of the recess, are axially aligned with the free spaces 11.

During production of the rotor 1, the following steps can be executed:
orienting a rotor laminated core 3 according to the invention, so that the rotation axis of the rotor laminated core 3 runs vertically and the terminal lamination 12 of the rotor laminated core 3 is arranged on the bottom side of the rotor laminated core,
inserting rotor magnets 10 into the magnet pockets 8 of the oriented rotor laminated core 3, so that the rotor magnets 10 bear axially against the narrowings of the recesses 13 in the terminal lamination 12,
orienting the rotor shaft 4, so that the rotor shaft runs vertically, and
pushing the oriented rotor laminated core 3 with the rotor magnets 10 onto the rotor shaft 4.

In addition, a further rotor laminated core 3 corresponding to the rotor laminated core 3 can be pushed onto the rotor shaft 4, so that magnetic poles of the two rotor laminated cores 3 are rotated with respect to each other about the rotor shaft 4.

### LIST OF REFERENCE SIGNS

1 Rotor
2 Rotor body
3 Rotor laminated core
4 Rotor shaft
5 Rotor end plates
6 Shaft nut
7 Rotor lamination
8 Magnet pocket
9 Recess
10 Rotor magnets
11 Free space
12 Terminal lamination
13 Recess
14 Projection
15 Edge section
16 Edge section

1. Rotor laminated core for a rotor of an electric machine, which rotor laminated core has a plurality of rotor laminations which are stacked axially one on the other and each have a recess,
wherein the recesses form a magnet pocket for receiving a rotor magnet,
wherein the rotor laminated core has a terminal lamination which is arranged on the axial side of the rotor laminated core and has a further recess which is axially aligned with the recess in the adjacent rotor lamination (Hand is narrowed with respect to the recess in the adjacent rotor lamination.

2. Rotor laminated core according to claim 1, wherein the recess in the terminal lamination is formed identically to the recess in the adjacent rotor lamination, apart from one or more projections which form the narrowing and project into the recess in the terminal lamination.

3. Rotor laminated core according to claim 2, wherein the recess in the terminal lamination has two mutually opposite edge sections and the projections are arranged on both edge sections.

4. Rotor laminated core according to claim 3, wherein one projection is arranged on a first edge section and a point which is situated opposite the projection on the second edge section is situated between two projections arranged on the second edge section.

5. Rotor laminated core according to claim 2, wherein each projection has an end section in the form of a segment of a circle.

6. Rotor or an electric machine, having a rotor shaft and a rotor laminated core according to claim 1 arranged on the rotor shaft, wherein a rotor magnet, which bears axially against the narrowing, is received in the magnet pocket.

7. Rotor according to claim 6, wherein a free space is formed between the rotor magnet and the plurality of rotor laminations stacked axially one on the other, and the recess in the terminal lamination is axially aligned with the free space.

8. Rotor according to claim 6, having a further rotor laminated core which corresponds to the rotor laminated core and is arranged on the rotor shaft, wherein magnetic poles of the two rotor laminated cores are rotated with respect to each other about the rotor shaft.

9. Rotor according to claim 6, wherein the rotor magnets are potted using a potting compound.

10. Electric machine having a rotor according to claim 6 and a stator, the rotor being rotatably mounted with respect to the stator.

11. Vehicle having an electric machine according to claim 10, which is provided for driving the vehicle.

12. Production method for a rotor (Hof an electric machine according to claim 6, comprising the steps of
orienting a rotor laminated core, so that the rotation axis of the rotor laminated core runs vertically and the terminal lamination of the rotor laminated core is arranged on the bottom side of the rotor laminated core,
inserting a rotor magnet into the magnet pocket of the oriented rotor laminated core, so that the rotor magnet bears axially against the narrowing,
orienting the rotor shaft, so that the rotor shaft runs vertically, and
pushing the oriented rotor laminated core with the rotor magnet onto the rotor shaft.

13. Production method according to claim 12, in which a further rotor laminated core corresponding to the rotor laminated core is pushed onto the rotor shaft, so that magnetic poles of the two rotor laminated cores are rotated with respect to each other about the rotor shaft.

14. Rotor laminated core according to claim 3, wherein each projection has an end section in the form of a segment of a circle.

15. Rotor for an electric machine, having a rotor shaft and a rotor laminated core according to claim 2 arranged on the rotor shaft, wherein a rotor magnet, which bears axially against the narrowing, is received in the magnet pocket.

16. Rotor according to claim 7, having a further rotor laminated core which corresponds to the rotor laminated core and is arranged on the rotor shaft, wherein magnetic poles of the two rotor laminated cores are rotated with respect to each other about the rotor shaft.

17. Rotor according to claim 7, wherein the rotor magnets are potted using a potting compound.

18. Electric machine having a rotor according to claim 7 and a stator, the rotor being rotatably mounted with respect to the stator.

19. Production method for a rotor of an electric machine according to claim 7, comprising the steps of
orienting a rotor laminated core, so that the rotation axis of the rotor laminated core runs vertically and the terminal lamination of the rotor laminated core is arranged on the bottom side of the rotor laminated core,
inserting a rotor magnet into the magnet pocket of the oriented rotor laminated core, so that the rotor magnet bears axially against the narrowing,
orienting the rotor shaft, so that the rotor shaft runs vertically, and
pushing the oriented rotor laminated core with the rotor magnet onto the rotor shaft.

20. Rotor laminated core according to claim 4, wherein each projection has an end section in the form of a segment of a circle.
